(19) United States
(12) Patent Application Publication
(10) Pub. No.: US 2004/0116293 A1
(43) Pub. Date: Jun. 17, 2004

(54) Enhanced herbicide composition

(76) Inventors: F. Paul Silverman, Highland Park, IL (US); Zhiguo Ju, Grayslake, IL (US); Peter D. Petracek, Grayslake, IL (US); Daniel F. Heiman, Libertyville, IL (US); Prem Warrior, Green Oaks, IL (US)

Correspondence Address: WOOD, PHILLIPS, KATZ, CLARK & MORTIMER, Citicorp Center, Suite 3800, 500 West Madison Street, Chicago, IL, 60661-2511, US

(21) Appl. No.: 10/619,347

(22) Filed: Jul. 14, 2003

Related U.S. Application Data
(60) Provisional application No. 60/433,830, filed on Dec. 16, 2002.

(51) Int. Cl. A01N 25/26; A01N 43/64; A01N 37/10

(52) U.S. Cl. 504/133; 504/144

(57) ABSTRACT

An herbicide composition comprising a PS II inhibitor and an SAR inducer and methods of its use.

### BACKGROUND OF THE INVENTION

A variety of herbicides have been used to kill unwanted plants (weeds) in crop fields or orchards. These herbicides are sprayed onto the soil (pre-emergence) or onto the weeds (post-emergence).

Herbicides are expensive, and their use may result in unintentional consequences such as damage to crop plants, groundwater contamination, environmental damage, the development of herbicide-resistant weeds, and human and mammalian health concerns.

There are many classes of herbicides that may be grouped based on their mode of action. One class of herbicides of particular interest is the inhibitors of the photosynthetic photosystem II (PSII). These include triazines, such as atrazine; triazinones, such as metribuzin; uracils, such as bromacil; nitrites, such as bromoxynil; benzothiadiazoles, such as bentazon; and ureas, such as diuron. PSII inhibitors act by inhibiting the transfer of electrons during photosynthesis. Inhibition blocks photosynthesis, the fixation of CO₂ and the production of ATP or NADPH. Plant death occurs due to the production of free radical species, which are able to initiate lipid peroxidation, and ultimately cell death.

The objects of the present invention are: (1) to reduce the amount of herbicide required for effective treatment, (2) to lessen the time between herbicide application and plant death, and (3) to increase the efficacy of PSII inhibitors such as atrazine and its salts to prevent the development of herbicide-resistant weeds.

### SUMMARY OF THE INVENTION

The present invention is directed to an herbicide composition comprising a PSII inhibitor and a salicylate or systemic acquired resistance (SAR) inducer.

The present invention is directed to a method of altering the herbicidal activity of a PSII inhibitor comprising adding to the PSII inhibitor an effective amount of a salicylate or SAR inducer. More particularly, the present invention is directed to a method of enhancing the herbicidal activity of a PS II inhibitor comprising adding to the PS II inhibitor an effective amount of a salicylate or SAR inducer. In practicing the method of the present invention, the salicylate or SAR inducer and the PS II inhibitor are applied concurrently or nearly concurrently to the soil or plants being treated.

The present invention is also directed to a method of controlling plant growth comprising applying to a plant an herbicidally effective amount of an herbicidal composition comprising a PS II inhibitor and a salicylate or SAR inducer.

### DETAILED DESCRIPTION OF THE INVENTION

A salicylate is defined as any substituted or otherwise unsubstituted benzoic acid having a hydroxyl group in the 2- or ortho-position, or a biologically acceptable salt or biological or chemical precursor thereof. Substitution on the benzoic acid includes mono- di-, tri- or tetra-substitution in the 3-, 4-, 5- and/or 6-positions: substituents may be chosen in any combination from: I an alkyl bridge containing 3 or 4 carbons attached to the benzoic acid at two adjacent points; lower alkoxy groups of from 1 to 4 carbons; the halogens fluorine, chlorine, bromine or iodine; an amino group, wherein the nitrogen may carry 0, 1, or 2 identical or different lower alkyl groups of from 1 to 4 carbons each; the nitro group; the formyl group; the acetyl group; the hydroxymethyl group; the methoxycarbonyl group; the carboxamido or sulfonamido groups wherein the nitrogen may carry 0, 1 or 2 identical or different lower alkyl substituents of from 1 to 4 carbons each; the cyano group; an alkylthio-, alkylsulfoxy or alkylsulfonyl group, wherein the alkyl group is comprised of from 1 to 4 carbons, or a mono-, di- or trifluoromethyl group. Also included in the definition of the term “salicylate” are the heterocyclic derivatives where one or more of the ring carbon atoms of the 2-Hydroxybenzoic acid are replaced with one or more nitrogen atoms. Representative of such derivatives are hydroxyl-pyridine carboxylic acids such as 3-hydroxypicolinic acid. Biologically acceptable salts include those of the common alkali metals sodium and potassium, the alkaline earths magnesium or calcium, zinc, or ammonium or simple alkylammonium cations such as mono-, di-, tri- or tetramethylammonium or other ammonium cations bearing up to 7 carbons. Biological or chemical precursors of 2-hydroxylated benzoic acid include non-hydroxylated benzoic acid and derivatives thereof having at least one ortho-position free, wherein the hydroxyl group is introduced biologically by the natural metabolic processes of the plant to which it is applied. Biological or chemical precursors of 2-hydroxylated benzoic acid also include benzoic acid compounds wherein the hydroxyl group in the 2-position is masked chemically in such a way that the masking group is labile and is easily removed once the compound has been applied to a plant, either by an enzymatic process of the plant's normal metabolism or by slow spontaneous hydrolysis. Examples of such masking groups include esters with monocarboxylic acids of from 1 to 7 carbons and trialkylsilyl ethers containing from 3 to 13 carbons.

Preferred salicylates include sodium salicylate, salicylic acid, 4-chlorosalicylic acid, 5-chlorosalicylic acid, 3,5-dichlorosalicylic acid and 3-hydroxypicolinic acid.

An SAR inducer is defined as any compound that promotes resistance in a plant to a disease-causing agent, which include, but are not limited to a virus, a bacterium, a fungus, or combinations of these agents. A component of the resistance response of plants to pathogens is the induction of pathogenesis-related proteins. In addition, an SAR inducer may induce resistance to insect feeding in a plant, as defined by Enyedi et al. (1992; Cell 70: 879-886). Exemplary SAR inducers cover many structural families of compounds, but are united by their ability to induce pathogenesis-related proteins, induce resistance to plant diseases and /or pest feeding. One class of SAR inducers is the salicylates. Another class of SAR inducers includes benzothiadiazole derivatives, such as Acibenzolar-S-methyl, sold as Actigard. Yet another example of an SAR inducer is 2,6-dichloroisonicotinic acid. Elicitors comprise another class of experimental SAR inducers that may have utility for this use.

The composition of the present invention contains from 50% to 0.0001% PSII inhibitor and from 50.0% to 0.001% salicylate or SAR inducer, preferably from 5.0% to 0.001% PSII inhibitor and from 1.0% to 0.01% salicylate or SAR inducer and most preferably from 0.5% to 0.05% PSII inhibitor and from 0.4% to 0.05% salicylate or SAR inducer.

The compositions of the present invention are dispersed or dissolved in water to a concentration of from 15% to 0.0015%, preferably 5.0% to 0.002% and most preferably 1.0% to 0.05% for application.

The composition of the present invention may also be formulated as a herbicidal concentrate which is sufficiently storage stable for commercial use and which is diluted with water before use. Such concentrates contain a concentration of from 99% to 0.01% of the herbicide plus salicylate or SAR inducer compositions of the present invention, preferably 50% to 0.1% and most preferably 40% to 1%. All percentages are weight percentages.

In an alternative embodiment of the present invention, the PS II inhibitor may be formulated as a concentrate, and the salicylate or other SAR inducer may be formulated as a separate concentrate. The two concentrates are then mixed and diluted prior to use.

Representative PSII inhibitors are atrazine, 6-chloro-N-ethyl-N′(1-methylethyl)-1,3,5-triazine-2,4-diamine; bentazon, 3-(1-methylethyl)-1H-2,1,3-benzothiadiazin-4(3H)-one 2,2-dioxide, and their salts. These include the atrazine formulation marketed as Aatrex Nine-O®, and any formulation containing a PS II inhibitor or its salts alone or in combination with other herbicides.

SAR inducers useful in the present invention include salicylates and Actigard™ (Acibenzolar-S-methyl=1,2,3-benzothiadiazole-7-carbothioic acid S-methyl ester; CAS Registry No. 135158-54-2), sold by Syngenta Crop Protection, Greensboro, N.C.

Compositions of the present invention include liquid compositions, which are ready for immediate use, and solid or liquid concentrate compositions, which require dilution before use, usually with water as the solvent.

The solid compositions may be in the form of granules or dusting powders wherein the active ingredient is mixed with a finely divided solid diluent (e.g. kaolin, bentonite, kieselguhr, dolomite, calcium carbonate, talc, powdered magnesia, Fuller's earth or gypsum). They may also be in the form of dispersible powders or grains, comprising a wetting agent to facilitate the dispersion of the powder or grains in liquid. Solid compositions in the form of a powder may be applied as foliar dusts.

Liquid compositions may comprise a solution, suspension or dispersion of the active ingredients in water optionally containing a surface-active agent, or may comprise a solution or dispersion of the active ingredient in a water-immiscible organic solvent, which is dispersed as droplets or micelles in water. Preferred active ingredients of the composition of the present invention are water-soluble herbicides or are readily suspended in water and it is preferred to use aqueous compositions and concentrates.

The composition of the present invention may contain additional surface active agents, including for example surface active agents to increase the compatibility or stability of concentrated compositions as discussed above. Such surface-active agents may be of the cationic, anionic, or non-ionic or amphoteric type or mixtures thereof. The cationic agents are, for example, quaternary ammonium compounds (e.g., cetyltrimethylammonium bromide). Suitable anionic agents are soaps, salts of aliphatic mono esters of sulphuric acid, for example sodium lauryl sulphate; and salts of sulphonated aromatic compounds, for example sodium dodecylbenzenesulphonate, sodium, calcium, and ammonium lignosulphonate, butylnaphthalene sulphonate and a mixture of the sodium salts of diisopropyl and triisopropylnaphthalenesulphonic acid. Suitable non-ionic agents are the condensation products of ethylene oxide with fatty alcohols such as oleyl alcohol and cetyl alcohol, or with alkylphenols such as octyl- or nonyl-phenol or octylcresol. Other non-ionic agents are the partial esters derived from long chain fatty acids and hexitol anhydrides, for example sorbitan monolaurate; the condensation products of the partial ester with ethylene oxide; the lecithins; and silicone surface active agents (water soluble of dispersible surface active agents having a skeleton which comprises a siloxane chain e.g. Silwet L77®). A suitable mixture in mineral oil is ATPLUS 411 F®.

Other adjuvants commonly utilized in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like, and can be formulated with liquid fertilizers or solid, particulate fertilizer carrier, such as ammonium nitrate, urea, and the like.

The rate of application of the composition of the present invention will depend on a number of factors including, for example, the active ingredients, the plant species whose growth is to be inhibited, the growth stage and density of the weed species, the formulation and the method of application, as for example, spraying, addition to irrigation water or other conventional means. As a general guide, however, the application rate as a spray is from 1000 to 10 liters of diluted spray solution per hectare, preferably from 200 to 100 liters per hectare.

Representative plant species that may be treated with the composition of the present invention include but are not limited to Nicotiana tabacum (tobacco) and Abutilon theophrasti (velvetleaf), but it is not intended that the use of the compositions and methods of this invention be limited only to those species.

The present invention may be illustrated by the following representative examples.

Procedures

In all examples, deionized ultra-pure water was used in preparing solutions. Spray solutions were used as soon as possible after mixing.

The herbicides and spray adjuvants used in these studies included: Crop oil concentrate (COC; Orchex 796, 83%; Ag Plus3OOf 17%), atrazine, Aatrex, Basagran (bentazon). The salicylates or SAR inducers included sodium salicylate (NaSA), salicylic acid (SA), other substituted salicylates, 2,6-dichloroisonicotinic acid and Actigard.

In all herbicide applications, plants were sprayed with a sufficient volume to insure good coverage, to the point of runoff of the spray solution. COC was added to all spray solutions at a rate of 0.25% (v/v). For all treatments containing both an herbicide and a salicylate or SAR inducer, these materials were mixed and applied in a single spray solution (commonly known as a tank mix). After spraying, plants were moved to the greenhouse and arranged in randomized complete blocks. Plants were evaluated for herbicidal effects (phytotoxicity) after spraying by assessing damage according to percent leaf area affected. All the data were subject to an analysis of variance, and the mean separations were determined with Duncan's multiple range test at α=0.05.

### EXAMPLE 1

The addition of salicylate increased atrazine herbicidal activity on tobacco (Table 1). The effect was apparent 3 days after herbicide application and persisted through 6 days after application.

TABLE 1
Effect of sodium salicylate (NaSA) on atrazine
(6-chloro-N-ethyl-N′-(1-methylethyl)-1,3,5-
triazine-2,4-diamine) herbicidal activity
on Xanthi-nc tobacco

| | Phytotoxicity at 3 days: | Phytotoxicity at 6 days: |
|---|---|---|
| Treatment | percent leaf area affected | percent leaf area affected |
| Crop oil | 0 A | 0 A |
| concentrate 0.25% | | |
| NaSA, 1600 ppm | 11 B | 10 B |
| Atrazine 100 ppm | 1.5 A | 66.2 C |
| Atrazine 100 + | 41.2 C | 82.5 DE |
| NaSA 1600 ppm | | |
| Atrazine 250 ppm | 4.3 AB | 77.5 D |
| Atrazine 250 + | 53.7 D | 86.2 EF |
| NaSA 1600 ppm | | |
| Atrazine 500 ppm | 9.5 B | 82.5 DE |
| Atrazine 500 + | 68.5 E | 90.5 F |
| NaSA 1600 ppm | | |

n = 5 plants.
Mean separation by Duncan's New Multiple Range (α = 0.05).
Means followed by the same letter are not statistically different.

### EXAMPLE 2

Salicylate potentiates Aatrex Nine-O®, a commercial atrazine formulation, on velvetleaf (Table 2).

TABLE 2
Effect of sodium salicylate (NaSA) on Aatrex
Nine-O ® (atrazine = 6-chloro-N-ethyl-N′-(1-
methylethyl)-1,3,5-triazine-2,4-diamine) herbicidal
activity on velvetleaf.

| | Phytotoxicity | Phytotoxicity | Phytotoxicity |
|---|---|---|---|
| | at 3 days: | at 5 days: | at 7 days: |
| | percent leaf | percent leaf | percent leaf |
| Treatment | area affected | area affected | area affected |
| Crop oil | 0 A | 0 A | 0 A |
| concentrate 0.25% | | | |
| NaSA, 800 ppm | 5 A | 5 A | 5 A |
| Atrazine 50 ppm | 17.5 B | 20 B | 25 B |
| Atrazine 50 + | 17.5 B | 35 C | 45 C |
| NaSA 800 ppm | | | |
| Atrazine 100 ppm | 35 C | 50 D | 45 C |
| Atrazine 100 + | 62.5 D | 87.5 E | 92.5 D |
| NaSA 800 ppm | | | |
| Atrazine 250 ppm | 80 E | 97.5 EF | 95 D |
| Atrazine 250 + | 82.5 E | 100 F | 100 D |
| NaSA 800 ppm | | | |

n = 4 plants.
Mean separation by Duncan's New Multiple Range (α = 0.05).
Means followed by the same letter are not statistically different.

### EXAMPLE 3

Salicylate potentiates Basagran®, a commercial bentazon formulation, on tobacco (Table 3).

TABLE 3
Effect of sodium salicylate (NaSA) on Basagran ®
(Bentazon = 3-(1-methylethyl)-1H-2,1,3-benzothiadiazin-
4(3H)-one 2,2-dioxide) herbicidal activity on Xanthi-nc tobacco.

| | Phytotoxicity at 4 days: percent leaf |
|---|---|
| Treatment | area affected |
| Crop oil concentrate 0.25% | 0 A |
| NaSA, 800 ppm | 7.5 A |
| Bentazon 100 ppm | 10 A |
| Bentazon 100 + NaSA 800 ppm | 32.5 B |
| Bentazon 250 ppm | 32.5 B |
| Bentazon 250 + NaSA 800 ppm | 62.5 C |
| Bentazon 500 ppm | 72.5 CD |
| Bentazon 500 + NaSA 800 ppm | 85 D |

n = 4 plants.
Mean separation by Duncan's New Multiple Range (α = 0.05).
Means followed by the same letter are not statistically different.

### EXAMPLE 4

Actigard® is a formulation of Acibenzolar-S-methyl, a commercial SAR inducer. Actigard showed a dose-dependent acceleration of atrazine activity on tobacco (Table 4). This demonstrates that inducers of SAR other than SA may also potentiate the herbicidal activity of atrazine.

TABLE 4
Effect of sodium salicylate (NaSA) or Actigard ®
(Acibenzolar-S-methyl) on Aatrex Nine-O ®
(atrazine = 6-chloro-N-ethyl-N′-(1-methylethyl)-
1,3,5-triazine-2,4-diamine) herbicidal activity on
Xanthi-nc tobacco.

| | Phytotoxicity | Phytotoxicity | Phytotoxicity |
|---|---|---|---|
| | at 2 days: | at 3 days: | at 7 days: |
| | percent leaf | percent leaf | percent leaf |
| Treatment | area affected | area affected | area affected |
| Crop oil | 0 A | 0 A | 0 A |
| concentrate 0.25% | | | |
| NaSA, 800 ppm | 1.7 A | 2.2 A | 4.1 A |
| Acibenzolar-S-methyl | 0 A | 0 A | 0 A |
| 187 ppm | | | |
| Acibenzolar-S-methyl | 0 A | 0 A | 0.6 A |
| 935 ppm | | | |
| Atrazine 100 ppm | 1 A | 17 B | 93.9 B |
| Atrazine 100 ppm + | 3 A | 28.5 C | 98.4 C |
| NaSA 800 ppm | | | |
| Atrazine 100 ppm + | 25 B | 57.5 D | 97.5 BC |
| Acibenzolar-S- | | | |
| methyl 187 ppm | | | |
| Atrazine 100 ppm + | 70 C | 86.2 E | 94.7 BC |
| Acibenzolar-S- | | | |
| methyl 935 ppm | | | |

n = 4 plants.
Mean separation by Duncan's New Multiple Range (= 0.05).
Means followed by the same letter are not statistically different.

### EXAMPLE 5

In addition to salicylic acid and its salts, other salicylates may potentiate the herbicidal activity of atrazine (Tables 5). Among the salicylates tested, greater potentiation than salicylic acid was seen with 3-chlorosalicylic acid, 3-fluorosalicylic acid, 4-fluorosalicylic acid, 5-fluorosalicylic acid, and 3,5-difluorosalicylic acid. Salicylates as active as salicylic acid in potentiating atrazine activity are 3-methoxysalicylic acid, 3-nitrosalicylic acid, 5-bromosalicylic acid, 5-nitrosalicylic acid, 6-fluorosalicylic acid, and 3,5-dibromosalicylic acid. Among the salicylates tested, no potentiation of atrazine was observed with sodium benzoate, 3-methylsalicylic acid, 4-methylsalicylic acid, 5-methylsalicylic acid, and 6-methylsalicylic acid.

TABLE 5
Activity of salicylates, picolinates and benzoates (2 mM)
to potentiate Aatrex Nine-O ® (atrazine = 6-
chloro-N-ethyl-N′-(1-methylethyl)-1,3,5-triazine-2,4-
diamine) herbicidal activity on Xanthi-nc tobacco.

| Treatment | Potentiation Rating¹ |
|---|---|
| Salicylic acid | 2 |
| Sodium benzoate | 0 |
| 3-Hydroxypicolinic acid | 3 |
| 3-Chlorosalicylic acid | 3 |
| 3-Fluorosalicylic acid | 3 |
| 3-Methoxysalicylic acid | 2 |
| 3-Methylsalicylic acid | 0 |
| 3-Nitrosalicylic acid | 2 |
| 4-Fluorosalicylic acid | 3 |
| 4-Methylsalicylic acid | 0 |
| 5-Bromosalicylic acid | 2 |
| 5-Fluorosalicylic acid | 3 |
| 5-Methylsalicylic acid | 0 |
| 5-Nitrosalicylic acid | 2 |
| 6-Fluorosalicylic acid | 2 |
| 6-Methylsalicylic acid | 0 |
| 3,5-Difluorosalicylic acid | 3 |
| 3,5-Dibromosalicylic acid | 2 |

n = 4 or 5 plants per treatment.
Mean separation by Duncan's New Multiple Range (= 0.05).
¹Potentiation rating: 0 = no potentiation; 1 = potentiation less than equimolar SA; 2 = potentiation statistically equal to equimolar SA; 3 = potentiation statistically greater than equimolar SA.

Inducers of SAR were also tested for their role as potentiators of atrazine (Table 7). Among the SAR inducers tested, greater potentiation than equimolar salicylic acid was observed with Acibenzolar-S-methyl, 2,6-dichloroisonicotinic acid, Probenazole, lactofen, and 4-chlorosalicylic acid, 5-chlorosalicylic acid, 3,5-dichlorosalicylic acid. The salicylates 4-chlorosalicylic acid, 5-chlorosalicylic acid and 3,5-dichloro salicylic acid are known SAR inducers (Conrath et al. 1995. Proc. Natl. Acad. Sci. USA 92:7143-7147). These data suggest that atrazine potentiation may be generalized across SAR inducers.

TABLE 6
Activity of Salicylic acid or SAR inducers to potentiate
Aatrex Nine-O ® (atrazine = 6-chloro-
N-ethyl-N′-(1-methylethyl)-1,3,5-triazine-2,4-diamine)
herbicidal activity on Xanthi-nc tobacco.

| Treatment | Potentiation Rating¹ |
|---|---|
| Salicylic acid | 2 |
| Acibenzolar-S-Methyl (Actigard) | 3 |
| 2,6-Dichloroisonicotinic acid | 3 |
| 4-Chlorosalicylic acid | 3 |
| 5-Chlorosalicylic acid | 3 |
| 3,5-Dichlorosalicylic acid | 3 |

n = 4 or 5 plants per treatment.
Mean separation by Duncan's New Multiple Range (= 0.05).
¹Potentiation rating: 0 = no potentiation; 1 = potentiation less than equimolar SA; 2 = potentiation statistically equal to equimolar SA; 3 = potentiation statistically greater than equimolar SA.

### EXAMPLE 6

The addition of a salicylate or SAR inducer increased PSII inhibitor activity under unfavorable environmental conditions. For example, the addition of salicylate potentiated atrazine herbicidal activity under low light, and conferred some activity in darkness (Table 7).

TABLE 7
Effect of sodium salicylate (NaSA) on Aatrex Nine-O ®
(atrazine = 6-chloro-N-ethyl-N′-(1-methylethyl)-1,3,5-
triazine-2,4-diamine) herbicidal activity on Xanthi-nc
tobacco at three different light levels.

| | Illumination (μmoles · m⁻² · s⁻¹) | | |
|---|---|---|---|
| Treatment | 31.3 | 9.8 | 0 (Dark) |

Phytotoxicity at 5 days: percent leaf area affected

| | | | |
|---|---|---|---|
| Crop oil concentrate 0.25% | 0 A | 0 A | 0 A |
| NaSA, 800 ppm | 0 A | 0 A | 5 BC |
| Atrazine 250 ppm | 1.9 AB | 0 A | 0.6 AB |
| Atrazine 250 ppm + NaSA 800 ppm | 11.9 CD | 5 BC | 5.9 C |

Phytotoxicity at 9 days: percent leaf area affected

| | | | |
|---|---|---|---|
| Crop oil concentrate 0.25% | 0 A | 0 A | 0 A |
| NaSA, 800 ppm | 0 A | 1.2 A | 13.8 AB |
| Atrazine 250 ppm | 67.2 B | 5.3 AB | 0.6 A |
| Atrazine 250 ppm + NaSA 800 ppm | 79.7 C | 46.9 C | 34.4 B |

Phytotoxicity at 13 days: percent leaf area affected

| | | | |
|---|---|---|---|
| Crop oil concentrate 0.25% | 0 | 0 A | 35.9 AB |
| NaSA, 800 ppm | 0 | 5.3 A | 54.7 BC |
| Atrazine 250 ppm | 100 | 76.5 B | 28.1 A |
| Atrazine 250 ppm + NaSA 800 ppm | 100 | 93.8 C | 82.8 D |

n = 4 plants.
Analysis within each light level for each time point.
Mean separation by Duncan's New Multiple Range (= 0.05).
Means followed by the same letter are not statistically different.

Salicylate also potentiated atrazine herbicidal activity under a range of temperatures (15-35 C)(Table 8). Therefore, the addition of a salicylate or an SAR inducer to a PSII inhibiting herbicide may provide a method for using the herbicide under less favorable environmental conditions, thus increasing its utility.

TABLE 8
Effect of sodium salicylate on Aatrex Nine-O ®
(atrazine = 6-chloro-N-ethyl-N′-( 1-methylethyl)-
1,3,5-triazine-2,4-diamine) herbicidal activity on
Xanthi-nc tobacco at three different temperatures.

| | Temperature | | |
|---|---|---|---|
| Treatment | 15 C. | 25 C. | 35 C. |

Phytotoxicity at 3 days: percent leaf area affected

| | | | |
|---|---|---|---|
| Crop oil concentrate 0.25% | 0 A | 0 A | 0 A |
| NaSA, 800 ppm | 0 A | 2.5 AB | 10.8 A |
| Atrazine 250 ppm | 0 A | 0 A | 11.0 AB |
| Atrazine 250 ppm + NaSA 800 ppm | 0 A | 11.9 C | 65.6 C |

Phytotoxicity at 5 days: percent leaf area affected

| | | | |
|---|---|---|---|
| Crop oil concentrate 0.25% | 0 A | 0 A | 0 A |
| NaSA, 800 ppm | 0 A | 2.5 AB | 14.1 B |
| Atrazine 250 ppm | 0 A | 0.6 A | 73.4 C |
| Atrazine 250 ppm + NaSA 800 ppm | 6.25 A | 36.6 C | 92.2 D |

Phytotoxicity at 7 days: percent leaf area affected

| | | | |
|---|---|---|---|
| Crop oil concentrate 0.25% | 0.6 A | 0 A | 0 A |
| NaSA, 800 ppm | 1.2 A | 2.5 AB | 18.8 B |
| Atrazine 250 ppm | 5.9 B | 25 C | 97.8 C |
| Atrazine 250 ppm + NaSA 800 ppm | 12.5 C | 73.4 D | 100 C |

Phytotoxicity at 10 days: percent leaf area affected

| | | | |
|---|---|---|---|
| Crop oil concentrate 0.25% | 0.6 A | 0 A | 3.1 A |
| NaSA, 800 ppm | 2.5 A | 1.9 A | 23.4 B |
| Atrazine 250 ppm | 39.1 B | 84.4 B | 100 C |
| Atrazine 250 ppm + NaSA 800 ppm | 43.8 B | 97.2 C | 100 C |

n = 4 plants.
Analysis within each temperature level for each time point.
Mean separation by Duncan's New Multiple Range (= 0.05).
Means followed by the same letter are not statistically different.

### EXAMPLE 7

Atrazine is commonly used against weeds in corn and small grain crops. As is shown in Table 9, foliar application of salicylate and atrazine had no negative effect on corn seedlings.

TABLE 9
Effect of sodium salicylate (NaSA) on Aatrex Nine-O ®
(atrazine = 6-chloro-N-ethyl-N′-(1-methylethyl)-
1,3,5-triazine-2,4-diamine) foliar sprays
on corn variety Silver Queen.

| Treatment | Percent leaf area affected at 3 days |
|---|---|
| Crop Oil Concentrate 0.25% | 0 A |
| NaSA, 800 ppm | 0 A |
| Atrazine 100 ppm | 0 A |
| Atrazine 100 + NaSA 800 ppm | 0 A |
| Atrazine 500 ppm | 0 A |
| Atrazine 500 + NaSA 800 ppm | 0 A |
| Atrazine 1000 ppm | 0 A |
| Atrazine 1000 + NaSA 800 ppm | 0 A |

n = 4 plants.
Mean separation by Duncan's New Multiple Range (α = 0.05).
Means followed by the same letter are not statistically different.

1. An herbicide composition comprising a PS II inhibitor and a salicylate or other SAR inducer.

2. An herbicide composition as in claim 1 wherein the PS II inhibitor is atrazine.

3. An herbicide composition as in claim 1 wherein the PS II inhibitor is bentazon.

4. An herbicide composition as in claim 1 wherein the PS II inhibitor is from 1.0% to 0.05% of the composition and the salicylate is from 0.5% to 0.05% of the composition.

5. An herbicide composition as in claim 1 that is dissolved in water.

6. An herbicide composition as in claim 5 wherein the water is from 0.1% to 99.9% of the composition.

7. The herbicide composition of claim 1 wherein the SAR inducer is a salicylate.

8. An herbicide composition as in claim 7 wherein the salicylate is sodium salicylate.

9. An herbicide composition as in claim 7 wherein the salicylate is salicylic acid or a salicylate derivative.

10. The herbicide composition of claim 1 wherein the salicylate is a hydroxypyridinecarboxylic acid or derivative thereof.

11. An herbicide composition as in claim 10 wherein the hydroxypyridinecarboxylic acid is 3-hydroxypicolinic acid.

12. An herbicide composition as in claim 1 wherein the SAR inducer is Acibenzolar-S-methyl.

13. An herbicide composition as in claim 1 wherein the SAR inducer is 2,6-dichloroisonicotinic acid.

14. An herbicide composition as in claim 1 wherein the SAR inducer is 4-chlorosalicylic acid.

15. An herbicide composition as in claim 1 wherein the SAR inducer is 5-chlorosalicylic acid.

16. An herbicide composition as in claim 1 wherein the SAR inducer is 3,5-dichlorosalicylic acid.

17. An herbicide composition as in claim 1 wherein the SAR inducer is an inducer of plant defense to pathogen attack.

18. A method of controlling plant growth comprising applying to a plant a herbicidally effective amount of a herbicidal composition of claim 1.
